(19) United States
(12) Patent Application Publication
(10) Pub. No.: US 2013/0124148 A1
(43) Pub. Date: May 16, 2013

(54) System and Method for Generating Editable Constraints for Image-based Models

(71) Applicants: Hailin Jin, San Jose, CA (US); Brandon M. Smith, Madison, WI (US)

(72) Inventors: Hailin Jin, San Jose, CA (US); Brandon M. Smith, Madison, WI (US)

(21) Appl. No.: 12/852,349

(22) Filed: Aug. 6, 2010

Related U.S. Application Data
(60) Provisional application No. 61/235,930, filed on Aug. 21, 2009.

(51) Int. Cl. G06F 17/50

(52) U.S. Cl. 703/1

(57) ABSTRACT

An image-based 3D model of an object may be generated from multiple images of the object captured from different viewpoints. 3D constraints which define the shape of the model may be generated from image data and camera parameters (intrinsic and extrinsic) of the images and from user-specified constraints. A user may specify constraints by outlining, on images of the object, features which define the shape of an object. An approximation of the object's 3D surface may be generated from depth maps computed from the images. The 3D constraints and surface approximation may be converted into a polygonal mesh representation, from which a visual display of the model may be reconstructed. The model may be displayed with a set of editable constraints which a user may manipulate to change the shape of the 3D model. The model may be stored as, and reconstructed from, the set of 3D constraints.

### PRIORITY INFORMATION

This application claims benefit of priority of U.S. Provisional Application Ser. No. 61/235,930 entitled “Methods and Apparatus for Casual Image-based Modeling of Curved Surfaces with Editable Primitives” filed Aug. 21, 2009, the content of which is incorporated by reference herein in its entirety.

### BACKGROUND

Three-dimensional (3D) modeling of physical objects has many applications in the area of computer graphics. For example, computer-based 3D models of objects may be employed to generate animation, to insert digital images into film or photographic images, to design objects, and for many other purposes. As computing power has increased and 3D modeling algorithms have become more sophisticated, it has become possible to model objects of increasing complexity. For example, an object model may include data representative of hundreds or thousands, or more, individual surfaces of a modeled object.

Conventional modeling or reconstruction techniques for 3D models may focus on obtaining very accurate shapes of the objects of interest. Such conventional techniques may use polygonal meshes, implicit functions, or other complex methods to represent 3D models. These representations may retain shape details necessary for reconstructing an extremely accurate 3D model. However, such representations may not be well suited for intuitive user editing of a 3D model. For example, a polygonal mesh representation of a 3D model having many vertices may be difficult to edit, particularly for a user unfamiliar with mesh representations of 3D models. The many surfaces represented by the mesh may present a cluttered and confusing display of the 3D model. And, in many cases, a user must move multiple vertices just to modify a single curve of an object. Accordingly, a user may find it tedious and difficult to modify a 3D model represented by a polygonal mesh.

Some conventional methods automatically select editable constraints from a mesh representation of a 3D model. However, this approach may present several challenges, as a mesh representation may be an imperfect model of an object. For example, a 3D model of an object may include “holes” in the model due to a lack of depth in the 3D mesh in a particular region of the model. Regions of a 3D model which contain “holes” due to a lack of 3D mesh information are unlikely to be selected as editable constraints, which can result in key regions of the model lacking editable features. Selecting appropriate editable constraints from a 3D mesh may be difficult because the constraints in the mesh which represent key, defining features of the object may not be obvious. As a result, regions of objects which are defining features of the object may not be included as editable constraints for a 3D model, while regions of the object which are not defining features of the object may be selected as editable constraints.

3D models reconstructed from complex representations under conventional techniques also require a significant amount of storage resources within a system. For example, a complex polygonal mesh representation of a 3D model with many detailed surfaces requires a large number of vertex positions to represent the many surfaces of the 3D model. Storing data representing all of the vertex positions of a complex 3D model may be a significant burden on computer systems with limited storage resources. Furthermore, transmitting a 3D model represented by a complex polygonal mesh representation which contains a large amount of data may also be a significant burden on network resources.

### SUMMARY

Various embodiments of a system and methods for generating editable constraints for image-based models are described. The system for generating editable constraints for image-based models may implement a constraint generation module configured to generate a three-dimensional (3D) model from a set of constraints. The constraint generation model may receive a plurality of images of an object which are captured from different viewpoints around the object. For example, an object may be photographed from a number of different angles, resulting in images which capture different surfaces of the object. The images may be calibrated, such that intrinsic and extrinsic camera parameters for the images are known. Using data and camera parameters from the images, the constraint generation model may generate a set of image-based constraints which approximates the 3D surface of the object.

The constraint generation model may also receive input specifying one or more shape constraints for the object. A user, via a user interface to the constraint generation module, may define a set of shape constraints for the object by specifying the shape constraints on one or more images of the object. For example, a user may indicate features which define the shape of the object by outlining (e.g., by tracing or drawing) the features on one or more images of the object. The object features, which may be points, lines or curves, may define the shape of the object and may be transformed by the constraint generation module into a set of user-specified constraints. The constraint generation module may convert the constraints specified by the user into a set of editable constraints which the user may manipulate, on a visual display of the 3D model, to change the shape of the 3D model.

The constraint generation module may use the image-based constraints and the user-specified constraints to generate a 3D model of the object. The set of image-based and user-specified constraints may be converted by the constraint generation model into a polygonal mesh representation of the 3D surface of the object. From the polygonal mesh representation, the constraint generation module may reconstruct a visual display of the 3D model of the object. The constraint generation module may display the 3D model with the set of editable constraints. The set of editable constraints may be a plurality of handles which the user may manipulate to change the shape of the 3D model. The 3D model may be stored as, and reconstructed from, the set of 3D constraints.

### BRIEF DESCRIPTION OF THE DRAWINGS

FIG. 1 illustrates an example embodiment of a constraint generation module.

FIG. 2 is a flowchart of a method for generating editable constraints for image-based models, according to various embodiments.

FIG. 3 illustrates several images of an object, captured from different perspectives of the object, according to various embodiments.

FIG. 4 illustrates an example embodiment of 3D model 150, displayed with a set of editable constraints

FIG. 5 illustrates a method for generating a set of image-based constraints from image data and camera parameters, according to various embodiments.

FIG. 6 illustrates a method for creating depth maps and generating an approximation of the 3D surface of an object depicted in multiple images, according to various embodiments.

FIG. 7 illustrates a method for receiving user-specified shape constraints and converting the user-specified shape constraints into editable, 3D constraints, according to various embodiments.

FIG. 8 illustrates a mesh vertex of position x and one-ring neighbors yᵢ according to various embodiments.

FIG. 9 illustrates a mesh vertex of position x and one-ring neighbors yᵢ according to various embodiments.

FIGS. 10a through 10c illustrate oriented position constraints according to various embodiments.

FIG. 11 illustrates pixel-position constraints according to various embodiments.

FIG. 12 illustrates an example of a computer system that may be used in various embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Introduction

A three-dimensional (3D) model of a physical object may be generated by capturing data from multiple images of the object taken from different viewpoints. For example, an object, such as a building, may be photographed from a number of different angles, resulting in images which capture different surfaces of the building. The multiple images may be captured using one or more cameras placed in multiple positions around the object. The images may be calibrated, such that intrinsic and extrinsic camera parameters for the images are known. Using data and camera parameters (e.g., intrinsic and extrinsic parameters) from the images of the object, a 3D model approximating the surfaces of the object may be generated. This technique of generating a 3D model for an object based on multiple images of the object may be referred to as image-based modeling. A 3D model generated using the technique of image-based modeling may be referred to as an image-based 3D model.

An image-based 3D model may be represented by a set of constraints which define an approximation of the surfaces of the modeled object. More specifically, the 3D model may be a set of constraints which define the shape of the 3D model (e.g., the constraints may represent curves and/or edges of the object). The 3D model may be reconstructed for visual display by extrapolating the surfaces of the 3D model from the set of constraints. As described in further detail below, the set of constraints which represent a 3D model of an object may be determined from image data and camera parameters from multiple images of the object taken from different viewpoints of the object.

The constraints which represent a 3D model may also be determined from information provided by a user. As described in further detail below, a user, via a user interface, may define a set of constraints for a 3D model of an object by specifying the constraints on one or more images of the object. For example, a user may indicate features which define the shape of the object by outlining (e.g., by tracing or drawing) the features on one or more images of the object. The object features, for example, may be points, lines or curves which define the shape of the object. As described in further detail below, the object features indicated by a user may be transformed into constraints which represent a 3D model of the object. The constraints may be editable constraints by which the user may manipulate the shape of the 3D model.

Examples of constraints that may be defined using image data, camera parameters, and/or user input may include, but are not limited to, planar curves, line segments (combined for polygons), points, straight lines (no end points), and/or points with normals. As described in further detail below, the set of constraints which represent a 3D model may be converted into a polygonal mesh representation of the 3D model. The polygonal mesh representation of the 3D model may be used to reconstruct a visual display of the 3D model. The visual display of the 3D model may include a set of editable constraints which are visible on the display of the 3D model. A user may manipulate the shape of the 3D model by manipulating the editable constraints on the display of the 3D model.

Conventional 3D model creation methods may generate a complex polygonal mesh representation of a 3D model that very accurately represents the shape of an object. Such conventional methods may provide the polygonal mesh representation of the 3D model as a mechanism for a user to edit the shape of the 3D model. However, editing the 3D model via the complex polygonal mesh representation may be tedious and non-intuitive for many users, as the surface of the 3D model may appear cluttered and many surfaces and vertices may need to be manipulated just to change a single feature (e.g., curve or line) of the 3D model. In contrast to such conventional methods, the system and methods for generating editable constraints for image-based models, as described herein, may generate an intuitively editable 3D model by representing, and displaying, the 3D model as a set of editable constraints, as described above. While a complex, polygonal mesh representation of a 3D model may support an extremely accurate reconstruction of the 3D model which very closely matches the actual shape of an object, a set of intuitively editable constraints of a 3D model may actually be more beneficial to a user.

A user's primary purpose for a 3D model of an object may be to create a new version of the object. More specifically, a 3D model of an object may be a baseline, or starting point for a user that wishes to modify the shape of the object in some way. Accordingly, a user whose primary goal is to make changes to a 3D model may only require a certain level of accuracy in the 3D model and may prefer to sacrifice a certain amount of accuracy in the 3D model in order to have a 3D model that is intuitively editable.

The set of 3D constraints may provide a complete representation of the 3D model which may be stored in a computer-accessible medium. The 3D model may be reconstructed, for example, for visual display and modification, from the set of 3D constraints. More specifically, the set of 3D constraints which represent the 3D model may be stored and subsequently retrieved from system memory as a persistent shape representation. Conventional methods store representations of 3D surfaces (for example, a connected mesh representation) of a 3D model, rather than the 3D constraints which define the shape of the 3D model. Storing a set of editable 3D constraints may provide an advantage to a user, as a 3D model reconstructed from the stored set of 3D constraints may provide the set of editable constraints to the user for further editing. Accordingly, the stored set of 3D constraints may enable the user to conveniently create multiple versions of the 3D model via multiple iterations of edits executed over a period of time. To support each iteration of edits, the system may reconstruct the 3D model from the set of constraints and display, to the user, the 3D model, including the set of editable constraints. The set of editable constraints displayed on the 3D model may represent the most recent edits to the 3D model completed by the user. Accordingly, it may be convenient for the user to continue editing the shape of the 3D model through further manipulation of the 3D constraints.

### Constraint Generation Module

Various embodiments of a system and methods for generating editable constraints for image-based models are described herein. Embodiments of an editable constraint generation method, which may be implemented as or in a tool, module, plug-in, stand-alone application, etc., may be used to create a set of editable constraints for an image-based 3D model. For simplicity, implementations of embodiments of the editable constraint generation method described herein will be referred to collectively as a constraint generation module.

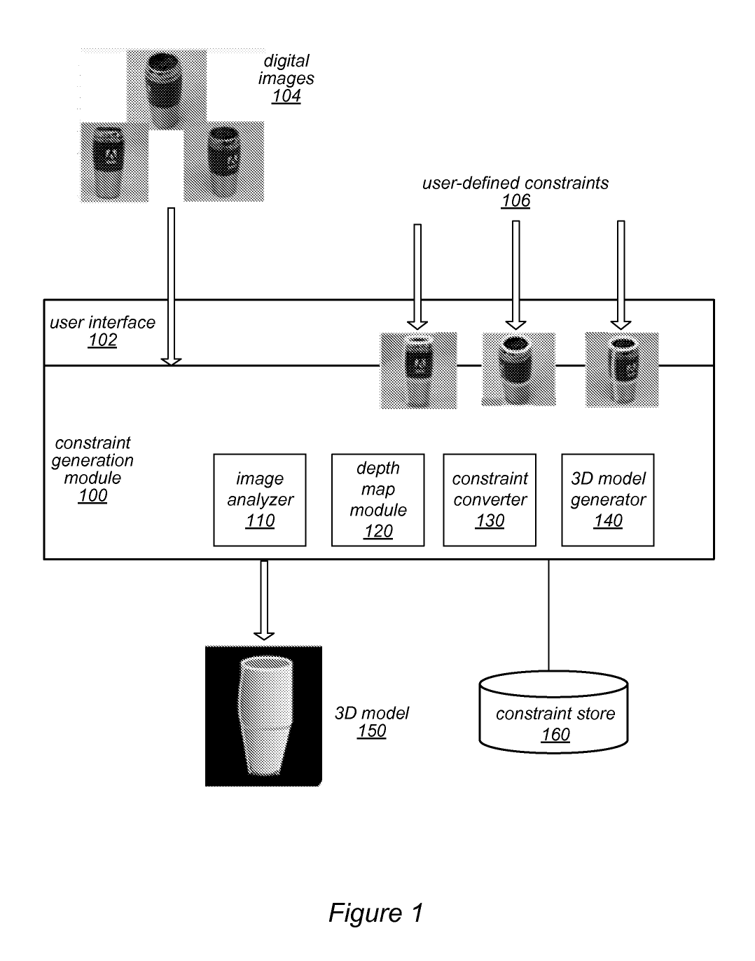

FIG. 1 illustrates an example embodiment of a constraint generation module which may be used to generate editable constraints which may represent an image-based 3D model. Constraint generation module 100 may provide a user interface 102 that includes one or more user interface elements via which a user may initiate, interact with, direct, and/or control the method performed by module 100. Constraint generation module 100 may be operable to obtain digital image data and camera parameters for a set of digital images 104. The set of digital images 104 may be multiple, calibrated images taken from different viewpoints around an object. Examples of digital images may include, but are not limited to, images captured by a digital camera, photographs scanned into a computer system, and video frames extracted from a digital video sequence. Digital image file types may include, but are not limited to Joint Photographic Experts Group (JPEG) files, Graphics Interchange Format (GIF) files, Tagged Image File Format (TIFF) files, or Portable Network Graphics (PNG) files.

Constraint generation module 100 may be operable to receive user input 106 specifying constraints which identify features (e.g., curves and/or edges) of an object depicted in digital images 104. User interface 102 may provide one or more textual and/or graphical user interface elements, modes or techniques via which a user may enter, modify, or select object feature constraints on digital images 104. For example, a user may, via user interface 102 of module 100, identify features of an object in digital images 104 by physically outlining the object features on one or more images, as illustrated by the user-defined constraints 106 shown in FIG. 1. Constraint generation module 100 may interpret the object features outlined by the user as constraints which the user desires to edit in a 3D model of the object. As described in further detail below, constraint generation module 100 may transform the object features outlined by the user into editable constraints for 3D model 150.

Constraint generation module 100 may be operable to determine a set of 3D constraints for the object depicted in digital images 104 using data and camera parameters from digital images 104 and user-defined constraints 106. Module 100 may also be operable to generate 3D model 150 of the object using the image data and camera parameters of digital images 104 and user-specified constraints 106. Module 100 may provide a visual display of 3D model 150 which includes editable constraints that may be used to change the shape of the 3D model.

3D model 150 illustrated in FIG. 1 may be defined by a set of constraints determined by module 100 from image data and camera parameters from digital images 104 and from user-defined constraints 106. Image analyzer 110, depth map module 120 and constraint converter 130 of module 100 may generate the set of constraints that define 3D model 150. Image analyzer 110 may use the image data and camera parameters from digital images 104 to generate a set of constraints that define the shape of the object depicted in digital images 104. Depth map module 120 may use image data and camera parameters from digital images 104 to generate a depth map for each image. From the generated depth maps, depth map module 120 may create a tessellated mesh representation of a 3D model that may approximate the 3D surface of the object. Constraint converter 130 may convert the user-defined constraints into a set of 3D constraints that may be used to further define the 3D shape of the object. 3D model generator 140 may use the constraints generated by both image analyzer 110 and constraint converter 130 and the 3D surface approximation generated by depth map module 120 to create 3D model 150. Constraint converter 130 may also convert user-defined constraints 106 into a set of editable constraints which may enable a user to manipulate the shape of 3D model of the object. Constraint generation module 100 may provide a visual display of 3D model 150 which may include the editable constraints generated by constraint converter 130.

Constraint generation module 100 may be operable to support editing and/or transformation of 3D model 150. For example, module 100 may be operable to allow a user to change the features of 3D model 150 by changing the position of existing editable constraints which define the features of 3D model 150. For example, via user interface 102, a user may select and move any of the various editable constraints displayed on 3D model 150. Such user manipulation of the editable constraints may change the shape of the 3D model. In some embodiments, module 100 may also be operable to allow a user to add additional editable constraints to 3D model 150, or delete exiting constraints from 3D model 150. For example, via user interface 102, a user may be able to draw or trace additional constraints on 3D model 150, which may be converted to editable constraints, similarly as described above, by constraint converter 130.

Constraint store 160 may be used to store the set of 3D constraints which represent the 3D model. As described above, the set of 3D constraints which represent the 3D model may provide a complete representation of the 3D model. Accordingly, the 3D model may be stored as a set of 3D constraints which may be written to or stored on any of various types of memory media, such as storage media or storage devices. The set of 3D constraints may be subsequently retrieved from system memory in order to reconstruct the 3D model, for example, for visual display and/or modification.

In various embodiments, constraint store 160 may be implemented via any suitable data structure or combination of data structures stored on any suitable storage medium. For example, constraint store 160 may be implemented as a collection of vectors, arrays, tables, structured data records, or other types of data structures. Such data structures may be stored, e.g., within a file managed by a file system of an operating system and stored on a magnetic, optical, or solid-state storage device such as a disk or solid-state mass storage device. Model data structures may also be stored as records within a database, as values within physical system memory (including volatile or nonvolatile memory) or virtual system memory, or in any other suitable fashion.

Constraint generation module 100 may be implemented as or in a stand-alone application or as a module of or plug-in for an image processing and/or presentation application. Examples of types of applications in which embodiments of module 100 may be implemented may include, but are not limited to, video editing, processing, and/or presentation applications, as well as applications in security or defense, educational, scientific, medical, publishing, digital photography, digital films, games, animation, marketing, and/or other applications in which digital image editing or presentation may be performed, e.g., where 3D aspects of scenes or image objects are relevant. Specific examples of applications in which embodiments may be implemented include, but are not limited to, Adobe® Photoshop® and Adobe® Illustrator®. In addition to generating 3D model 150, module 100 may be used to display, manipulate, modify, and/or store the 3D model and/or image, for example to a memory medium such as a storage device or storage medium.

Work flow

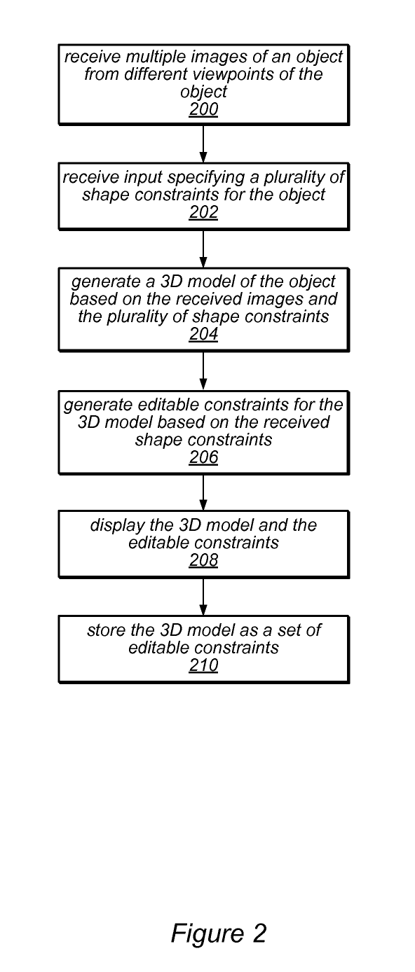

FIG. 2 illustrates one embodiment of a method for generating editable constraints for image-based models. In some embodiments, constraint generation module 100, illustrated in FIG. 1, may implement the method of FIG. 2 to generate an image-based 3D model including editable constraints which may enable a user to change the shape of the 3D model. Editable constraints which define the shape (e.g., curves and edges) of a 3D model may provide a more intuitive editing environment than a conventional mesh representation of the 3D model. For example, editable constraints may provide a user with high-level, intuitive control over the shape of the 3D model without the need to directly manipulate many vertices of the 3D model, as required by conventional mesh representations.

The method illustrated in FIG. 2, as indicated at 200, may include receiving multiple digital images of an object from different viewpoints of the object. Multiple images of an object may be captured, such as with a digital camera, from different perspectives of the object. For example, one image may capture the view of a building from a position directly perpendicular to one of the sides of the building, while another image may capture a view of the same building from a position oriented at a slight angle to the side of the building. In some embodiments, constraint generation module 100 may extract 3D surface information for the object from the multiple images of the object and use the 3D surface information to create a 3D model of the object. More specifically, as described in further detail below, constraint generation module 100 may be configured to recover relational data of the 3D surface of the object from the set of digital images of the object.

The number of images used to represent different viewpoints of an object may vary from embodiment to embodiment and may also depend on the characteristics of the various surfaces of the object. A larger number of images may be needed to represent an object with complex, three-dimensional surface characteristics (e.g., curves, creases, ridges, valleys, etc.) and a smaller number of images may be needed to represent an object with relatively flat, planar surfaces. In some embodiments, a range of 30-40 images may provide sufficient 3D surface information for the object. At least two images of a particular surface of an object may be needed to extract image data from which the 3D characteristics of the surface may be determined. The multiple images may be images captured by a digital camera, video frames extracted from a digital video sequence, or digital images obtained by various other means. The multiple images may be of various file types, including, but not limited to, JPEG, GIF, TIFF, and/or PNG.

Constraint generation module 100, as indicated at 202 of FIG. 2, may receive input specifying a plurality of shape constraints for the object depicted in digital images 104. As illustrated in FIG. 1 and described above, module 100, via user interface 102, may receive user input 106 which may specify shape constraints for the object. The shape constraints specified by the user may identify features (e.g., curves and/or edges) which define the surface, or shape, of the object. In some embodiments, the user may identify the features of an object by physically outlining (e.g., drawing or tracing) the features directly on the multiple images of the object. For example, user interface 102 of constraint generation module 100 may display the set of object images to the user and provide the user with a drawing mechanism by which the user may identify features of the object directly on the object images. A user may interact with one or more of the images of the object to identify object features such as curves, lines or points shown in the image.

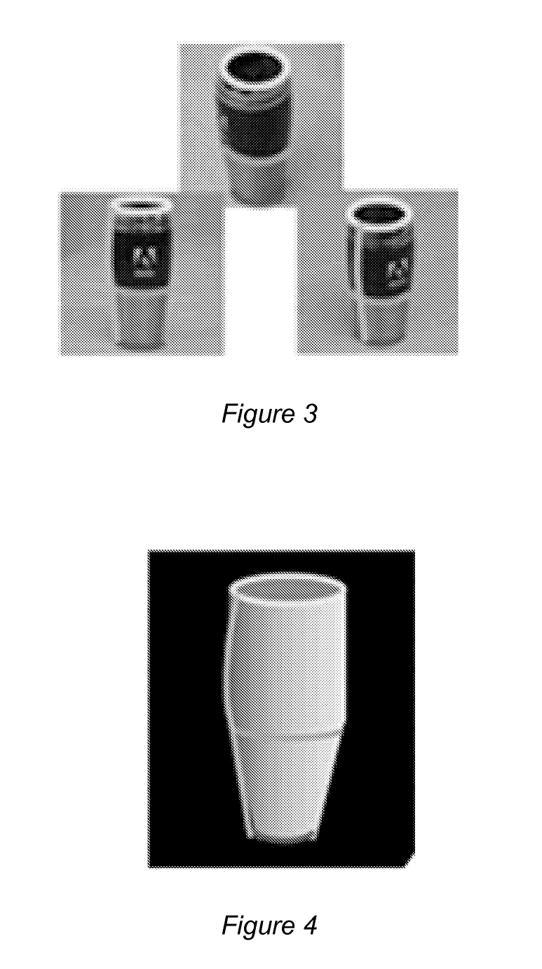

FIG. 3 illustrates several images of an object, captured from different perspectives of the object. As an example, the images of FIG. 3 may correspond to digital photographic images captured with a digital camera, or digitized from several photographs. Constraint generation module 100 may be configured to present images such as illustrated in FIG. 3 and/or other available images of an object to a user, either sequentially or in combinations. The user may interact with the images to identify particular features of the depicted object. For example, as shown in FIG. 3, the user may identify the rim of a cup as a feature of the cup by outlining the rim of the cup in each image in which the rim is visible. As another example, also illustrated in FIG. 3, the user may identify a curve around the center of the cup by outlining the center curve in each image in which the center curve appears. Constraint generation module 100 may interpret the object features outlined by the user as constraints which the user desires to edit in the 3D model of the object. As described in further detail below, constraint generation module 100 may transform the object features outlined by the user into editable constraints for 3D model 150.

The method illustrated in FIG. 2 may include, as indicated at 204, generating a 3D model of the object based on the received images and the plurality of shape constraints. Image analyzer 110 of constraint generation module 100 may generate constraints which define the 3D shape of the object from the image data and camera parameters of digital images 104. Such constraints extracted from the image data and camera parameters of multiple images may be referred to herein as image-based constraints. As described in further detail below, image analyzer 110 may locate similar image regions across digital images 104 and use the camera parameters for the images to generate constraints which may define the surfaces of the object depicted in the similar image regions. Depth map module, 120, as described in further detail below, may use the image data and camera parameters from digital images 104 to create depth maps for each digital image. Using the depth maps, depth map module 120 may create a tessellated mesh that may represent an approximation of the 3D surface of the object. As described in further detail below, constraint converter 130 may convert the user-defined constraints into a set of 3D constraints that may be used to further define the 3D surface of the object. 3D module generator 140 of constraint generation module 100 may use the constraints extracted from digital images 104, the user-specified constraints from constraint converter 130 and the 3D surface approximation from depth map module 120 to generate 3D model 150 of the object. Embodiments of the methods which may be implemented by 3D module generator 140 to create the 3D model are described in further detail below.

As indicated at 206 of FIG. 2, the method for generating editable constraints for image-based models may include generating editable constraints for the 3D model based on the received shape constraints. As described in further detail below, constraint converter 130 may generate 3D constraints from the user-specified constraints and may convert the 3D constraints into a set of editable constraints which may enable a user to modify the shape of the 3D model. In some embodiments, the set of editable constraints may also include all or some of the constraints extracted, as described above, from the image data and camera parameters of digital images 104. A user may specify, via user interface 102, whether the image-based constraints, determined from the image data and camera parameters, are included in the set of editable constraints for the 3D model of the object. In addition to specifying whether image-based constraints are included as editable constraints, a user may also specify, via user interface 102, particular ones, or all, of the image-based constraints which may be included in the set of editable constraints.

As indicated at 208 of FIG. 2, constraint generation module 100 may display 3D model 150 and the set of editable constraints. The display of 3D model 150 may include the set of editable constraints generated, as described above, for the 3D model. For example, module 100 may display the set of editable constraints by overlaying the editable constraints directly on the display of 3D model 150. FIG. 4 illustrates an example of 3D model 150, displayed with the set of editable constraints defined by a user in FIG. 3. As described in further detail below, the set of editable constraints displayed on 3D model 150 may be a set of “live” constraints which may be manipulated, by the user, directly on 3D model 150, to modify the shape of 3D model 150. For example, a user may select an editable constraint and modify the shape of the corresponding feature of the 3D model by dragging, pulling, pushing or otherwise manipulating the constraint. The display of 3D model 150 may be updated to reflect the changes made to the constraint by the user. A user, via user interface 102 of constraint generation module 100, may also add one or more new constraints to the 3D model, or remove constraints from the 3D model.

The method illustrated in FIG. 2 may include, as indicated at 210, storing the 3D model as a set of constraints. As described above, the set of 3D constraints which represent the 3D model may provide a complete representation of the 3D model. Accordingly, the 3D model may be stored as a set of 3D constraints which may be written to or stored on any of various types of memory media, such as storage media or storage devices. For example, constraint store 160 may be used to store the set of 3D constraints which represent the 3D model. The set of 3D constraints may be subsequently retrieved from system memory in order to reconstruct the 3D model, for example, for visual display and/or modification.

### Image-based Constraints

In some embodiments, image analyzer 110 may use the image data and camera parameters from digital images 104 to generate a set of image-based constraints that represent the surfaces of an object depicted in digital images 104. For example, the image-based constraints may represent the features (e.g., curved surfaces) that define the 3D shape of the object. To generate the set of image-based constraints, image analyzer 110 may analyze the image data of individual images in the set of digital images 104 to locate image data that indicates or is associated with definitive features (e.g., curved surfaces, edges, boundaries) of the object in an image. In some embodiments, image data for digital images 104 may correspond to data or information about pixels that form the image, or data or information determined from pixels of the image. Subsequent to analyzing individual image data to determine object features, image analyzer 110 may analyze the image data of the set of digital images 104 to locate images that contain similar regions (e.g. regions that depict similar object features). Using the camera parameters for multiple images that contain similar regions, image analyzer 110 may recover relational data of the 3D surface of the object.

In some embodiments, the set of digital images 104 may be calibrated, such that intrinsic and extrinsic image and camera parameters for the images are known. For example, digital images 104 may have been encoded with information explicitly identifying the camera position (e.g., in terms of geospatial coordinates), focal length, and/or other extrinsic (e.g., positional) and intrinsic parameters relevant to the image capture, such that the relative camera motion around the object that is indicated by different images of the object may be determined from this identifying information. In some embodiments, even when positional data for digital images 104 relative to each other, or the imaged object, is not known, camera motion recovery algorithms may be employed to determine camera motion data from digital images 104. For example, the location of image features relative to common landmarks and/or reference points within the images may be analyzed to determine the relative camera positions. From the camera motion data, image analyzer 110 may identify the relative positions (on the surface of the object) of object features depicted in multiple images. Using the relative positions of identified object features and 3D surface information derived from the images, image analyzer 110 may to transform the image data into image-based constraints which represent the object features.

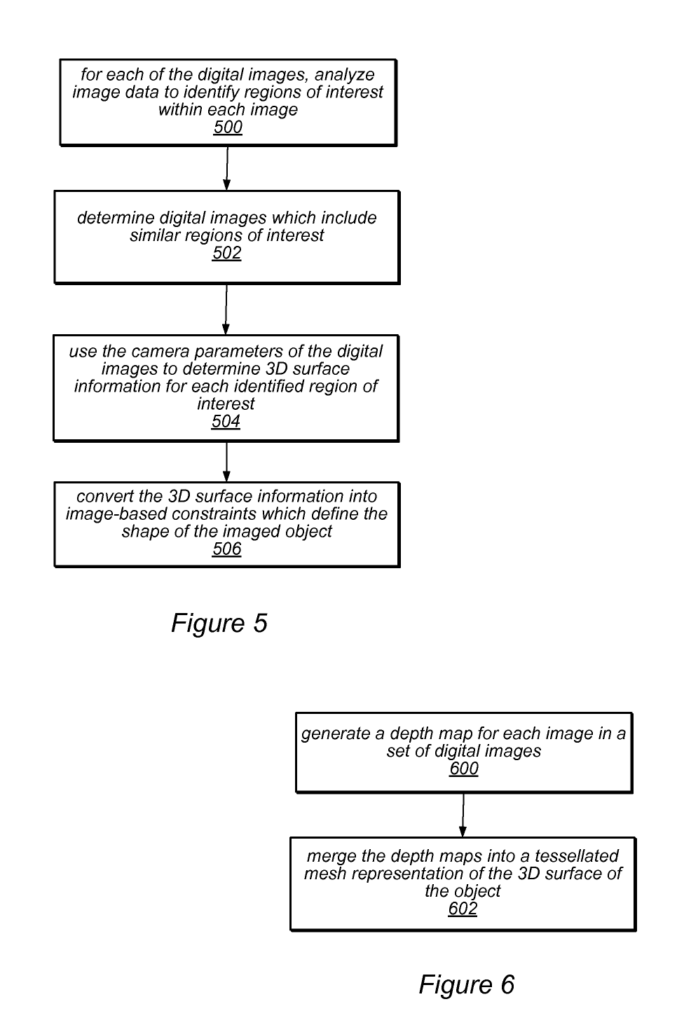

A method that may be implemented by image analyzer 110 to generate the set of image-based constraints from the image data and camera parameters of digital images 104 is illustrated in FIG. 5. As indicated at 500 of FIG. 5, the method may include, for each image in the set of digital images 104, analyzing image data to identify regions of interest within the image. Image analyzer 110 may locate image data that indicates or is associated with definitive features of the imaged object. For example, image analyzer 110 may perform edge detection to locate image data which represents one or more edges of the object. As another example, image analyzer 110 may perform apparent contour detection to locate image data which represents the contour of the object. As yet another example, image analyzer 110 may perform foreground and background separation to locate image data which may represent the occluding boundaries of the object. In some embodiments, image analyzer 110 may also perform interest point and/or patch detection to identify points or regions in an image which may contain a dense set of image data and may have suitable characteristics such that the points or regions may be accurately matched to similar points or regions across multiple images.

Image analyzer 110 may perform edge detection to locate image data which may indicate one or more edges of an object in an image. Various embodiments of image analyzer 110 may employ various techniques or methods for detecting edges of an object in an image. As an example, image analyzer 110 may detect edges of an object in an image by identifying image data points which indicate sharp changes, or discontinuities, in image brightness. Changes in brightness across an image may likely correspond to changes in depth, surface orientation and/or material properties, and, thus, may likely indicate a boundary between different objects in an image. A change in intensity values across multiple pixels in an image may represent a change in brightness which indicates an object edge. Image analyzer 110 may compute a derivative of the change in intensity values to determine whether an intensity change represents an object edge.

Image analyzer 110 may employ various methods to compute the derivative of the intensity change in order to detect an object edge. For example, image analyzer 110 may employ a search-based method or a zero-crossing based method. A search-based method for object edge detection may calculate a first derivative of an intensity change in image data to determine the intensity gradient of the image data. The search-based method may search for local directional maxima of the intensity gradient to locate peaks of intensity across an image. A zero-crossing method for object edge detection may calculate a second derivative of an intensity change in image data to determine the rate of change of the intensity gradient of the image data. The zero-crossing method may locate zero-crossing points of the intensity gradient to determine local maxima in the intensity gradient. Such zero-crossing points of the intensity gradient in the image may correspond to object edges.

In some embodiments, image analyzer 110 may apply a threshold to the intensity change derivatives calculated by either of the two methods above (or, a different method) to determine which derivatives may be classified as object edges. For example, derivatives with a value over a certain threshold may be considered object edges. To reduce the effects of noise which may be present in the image data, image analyzer 110 may apply hysteresis (e.g., upper and lower values) to the threshold. For example, image analyzer 110 may begin defining an edge at a point at which the derivative of the image data is above the upper level of the determined threshold. Image analyzer 110 may trace the path of the edge, pixel by pixel, continuing to define the path as an edge as long as the derivatives of the image data remain above the lower level of the threshold. The path may no longer be considered an edge when the image data derivatives fall below the lower level of the threshold. This method of defining an edge may be based on an assumption that object edges are likely to exist in continuous lines. Note that other algorithms or techniques for detecting object edges in an image may be used.

Image analyzer 110 may perform apparent contour detection to locate image data which may indicate apparent contours in an image. Apparent contours may be viewpoint-dependent contours (e.g., the appearance of the contour changes dependent on the angle at which the contour is viewed) which are the result of occluding objects with smooth-curved surfaces. For example, a portion of a surface of an object in an image may be occluded by another object in the image. The viewpoint, or viewing direction, of the image may be tangent to a smooth-curved surface of the occluding object, such that the boundary of the smooth surface is projected onto the imaged object. In such a case, at the occluding boundary, the imaged object may appear to have an actual contour, even though there may be no actual texture, lighting or geometry discontinuity in the surface of the imaged object. The actual contour may change dependent on the viewing angle, and, thus may change across multiple images of an object taken from different viewpoints of the object. As a result, apparent contours may an inaccurate indication of the shape of an imaged object. Apparent contours may also provide inaccurate results when matched across multiple images, due to the viewpoint-dependent nature of the apparent contours. Accordingly, image analyzer 110 may detect apparent contours of an object in an image in order to distinguish between actual contours that provide an accurate representation of an object's shape from apparent contours which may provide an inaccurate representation of an object's shape.

Image analyzer 110 may perform foreground and background separation to locate image data which may represent the occluding boundaries of an imaged object. Various embodiments of image analyzer 110 may employ various techniques or methods for detecting and separating the foreground and background in an image. For example, in some embodiments, image analyzer 110 may assume the background of an image is located at the sides of the image and the foreground of an image is located at the center of the image. Image analyzer 110 may then determine the intensity distribution of both foreground and background areas of the image from the center image data and the side image data, respectively. From the intensity distribution, image analyzer 110 may determine Gaussian models for the foreground and background areas of the image. The Gaussian models may be applied to a whole image and each pixel of the image may be classified as either a foreground pixel or background pixel. Image analyzer 110 may assume that an imaged object exists in the foreground area of an image and, thus, may identify foreground pixels as the imaged object. In other embodiments, image analyzer 110 may determine foreground and background areas of an image using doing a statistical analysis of pixel distributions across the image.

Image analyzer 110 may detect interest points or patches in each image which may have suitable characteristics such that the points or patches may be accurately matched to similar points or regions across multiple images. As described in further detail below, points or regions matched across multiple images, along with camera parameters for the images may be used to determine 3D surface information of an imaged object. Regions of an image which may be identified as interest points or patches may be defined by a set of characteristics which may enable the regions to be accurately matched across multiple images. Examples of the characteristics of such regions may include, but are not limited to: a well-defined position in image space; a significant amount of rich image data (e.g., such that the region may be distinguishable over other image regions); and stable image data that is not significantly affected by changes within the image, for example perspective transformations or illumination/brightness variations (e.g., such that the region may be reasonably reproduced with a high degree of accuracy).

As an example of interest patch detection, image analyzer 110 may detect, via analysis of image data, an interest region that is either brighter or darker than regions surrounding the interest region. The interest region may signal the presence of an object in the image. Image analyzer 110 may use the interest region, along with determined edge and boundary information for an object (as described below), to accurately determine the location of an object in the image. Image analyzer 110 may also match the interest region, if the interest region meets the characteristics described above, to similar regions in other images and extract 3D surface information from the object using the camera parameters for the images.

Image analyzer 110, as indicated at 502 of FIG. 5, may determine digital images which include similar regions of interest. More specifically, image analyzer 110 may determine all of the digital images which contain each of the object features (e.g. similar regions of interest) identified as described above. For example, image analyzer 110 may compare object features across multiple digital images to find matching object features across multiple digital images. To compare object features, image analyzer 110 may analyze one or more attributes of the point (e.g., image pixel) which are included in the object features. Examples of attributes that may be used by image analyzer 110 to compare object features may include, but are not limited to, the position in the image of the object feature point, and the magnitude and/or orientation of a gradient associated with the object feature point. The magnitude and/or gradient associated with an object feature point may represent the color and/or intensity of the pixel at the object feature point.

Image analyzer 110 may quantify the attributes of each object feature and may compare the quantified values between a pair of object features to determine a measure of similarity between the pair of object features. In some embodiments, image analyzer 110 may compute a measure of similarity between a pair of object features by calculating a Euclidean distance between the two object features. For example, the Euclidean distance (dᵢⱼ) between an object feature i and an object feature j may be computed as in equation (1):

$${d}_{ij} = \sqrt{{\sum }_{k = 1}^{n} {( {x}_{ik} - {x}_{jk} )}^{2}} \qquad ( 1 )$$

for n number of parameters x. Image analyzer 110 may determine whether the pair of object features are a match based on the value of the Euclidean distance (dᵢⱼ) between the two object features. For example, if the distance between the two object features is below a certain threshold, the object features may be considered matched. The distance threshold below which two object features may be considered a match may vary from embodiment to embodiment. Upon completion of the object feature comparison process, each identified object feature may be associated with a group of multiple images which contain the object feature.

Image analyzer 110, as indicated at 504 of FIG. 5, may use the camera parameters of the digital images to determine 3D surface information for each identified region of interest. As described above, the set of digital images 104 may be calibrated, such that intrinsic and extrinsic image and camera parameters for the images are known. For example, digital images 104 may be encoded with information explicitly identifying the camera position (e.g., in terms of geospatial coordinates), focal length, and/or other extrinsic (e.g., positional) and intrinsic parameters relevant to the image capture, such that the relative camera motion around the object that is indicated by different images of the object may be determined from this identifying information. Examples of intrinsic parameters may include, but are not limited to, focal length, aspect ratio, pixel skew, image center, and lens distortion. Examples of extrinsic parameters may include, but are not limited to, 3D orientations and positions. The extrinsic parameters of an image may not be dependent on the type of camera used to capture the image.

Various embodiments of image analyzer 110 may employ various techniques or methods for determining 3D surface information of an imaged object from camera parameters encoded in multiple images of the object. In some embodiments, image analyzer 110 may determine the relative position of a region of interest identified in multiple images (as in 502 of FIG. 5) using the camera motion data and other image parameters. For example, using the orientation and lens properties of one or more cameras used to capture multiple images of a region of interest, image analyzer 110 may perform a triangulation procedure to determine a 3D position of the region of interest, relative to the camera(s) position. For example, the 3D position and orientation (e.g., unit normal vector) of a patch on the surface of a 3D object may be obtained using relative positional information from image data of multiple images which contain the same patch. Similarly, the 3D positions and orientations of points, edges (e.g., lines or curves) and/or other identified object features may be determined using relative positional information from image data of multiple images which contain the same object feature. The relative 3D position of each of the identified points of interest in digital images 104 may indicate 3D surface information for the imaged object. As indicated at 506 of FIG. 5, image analyzer 110 may convert the 3D surface information into image-based constraints which define the shape of the imaged object.

### Depth Maps

As described above, depth map module 120 may use the image data and camera parameters from digital images 104 to generate multiple depth maps for digital images 104. A depth map may be a set of data in which each data value corresponds to a depth, or 3D position, for a corresponding pixel in an image. From the generated depth maps, depth map module 120 may create a tessellated mesh representation of a 3D model that may approximate the 3D surface of an imaged object. FIG. 6 illustrates a method that may be implemented by depth map module 120 to create depth maps, and from the depth maps, generate an approximation of the 3D surface of an object depicted in digital images 104. The method illustrated in FIG. 6 and described below may use a window-based search algorithm for computing depth maps from multiple digital images. The window-based search algorithm may create depth maps only for portions of an image that can be accurately matched to other, neighboring images. As a result, each depth map may contain one or more incomplete surfaces for an imaged object. For example, incomplete surfaces may exist for image regions which have effects that are difficult to match, such as occlusions, low-textured regions, and/or oblique surfaces. However, such effects may typically occur at different regions on an object in different images. As a result, the presence of incomplete object surfaces may be minimized by merging multiple depth maps to generate a 3D surface approximation of the object. In other embodiments, techniques and methods other than a window-based search algorithm may be employed to generate depth maps for digital images 104. For example, graph cuts and belief propagation based methods may be used by depth map module 120 to generate depth maps.

As indicated at 600, the method illustrated in FIG. 6 may include generating a depth map for each image in a set of digital images. As described above, the set of digital images may be calibrated images taken from multiple viewpoints around an object. Each of the multiple images may represent a different view of the imaged object. Depth map module 120 may, as described in further detail below, create a depth map for each view of an object by correlating each view (e.g., a reference view) against a set of neighboring views (e.g., images captured in close proximity to the reference view) using a window-matching algorithm.

Depth map module 120 may, for each pixel of an object in a reference view, compare image data within a window centered around the pixel to image data contained in windows centered around corresponding pixels in multiple neighboring views. For a pixel p in a reference view, depth map module 120 may define an m×m (where m represents a number of pixels) square window (e.g., a reference window) centered around the pixel. For the pixel p inside the bounding volume of an object in a reference view, depth map module 120 may project a vector from the pixel position to the relative camera position of the image. Depth map module 120 may recognize multiple depth positions at various locations along the projected vector. Various embodiments may recognize different depth positions along the projected vector. For example, depth map module 120 may recognize depth positions at certain distances along the projected vector. As another example, depth map module 120 may recognize a certain number of depth positions along the projected vector, regardless of the length of the projected vector.

Each depth position along the projected vector may represent a 3D location in space, between the actual pixel position on the image and the relative camera position. For each depth position, depth map module 120 may project a vector from the 3D location represented by the depth position to each neighboring view of the object. Using the projected vectors, depth map module 120 may determine a corresponding pixel location in each of the neighboring views. For corresponding pixels in neighboring images, depth map module 120 may define an m×m window (e.g., a neighboring window) centered around each pixel. Various embodiments may use different sizes to define the window centered around a pixel. In some embodiments, a larger window size may result in smoother depth maps. As an example, a window size of 5×5 may result in sufficient accuracy and smoothness in the resulting depth maps. Depth map module 120 may compare the reference window for a pixel p to the neighboring windows located via projections of depth position d. Based on the comparison, as described in further detail below, depth map module 120 may determine whether the a measured depth value of d is valid for use in a depth map.

Depth map module 120 may select neighboring views to a reference view based on the relative camera positions for each view. For camera positions around a ring encircling the object or distributed on a hemisphere, neighboring views may be selected based on an angular distance between the optical axes of two views. For example, depth map module 120 may evaluate the angular distance between a view and the reference view. Depth map module 120 may select a number of views with angular distances closest to (e.g., the smallest angular distances) the reference view as the set of neighboring views. In some embodiments, neighboring views within a certain angular distance of the reference view (e.g., views too close to the reference view) or another neighboring view, may be excluded from the selection. As an example, neighboring views with an angular distance less than an angular distance threshold of four degrees from the reference view, or another neighboring view, may be excluded from the selection. In other embodiments, other values may be used for the angular distance threshold. In various embodiments, different values may be used to determine the number of views that are selected for the set of neighboring views.

Depth map module 120 may compute a normalized cross-correlation (NCC) score for each neighboring window by comparing each neighboring window to the reference window centered around the pixel in the reference view. In some embodiments, a high NCC score may indicate that image data of a neighboring window is similar to image data of the reference window, and, therefore, may indicate that the two views represented by the windows are likely to include the same surface area of a textured object. In some embodiments, a low NCC score may indicate poor correlation between the neighboring and reference windows, and, therefore, may indicate that the two views represented by the windows are not likely to include the same surface area of a textured object. The poor correlation between the windows may be due to an occlusion of the object, a specular highlight, or other factor within one, or both, of the images. Accordingly, depth map module 120 may determine that neighboring windows with an NCC score above a certain threshold represent neighboring views that are a match to the reference view.

Based on the NCC scores for the neighboring views, depth map module 120 may determine a number of neighboring views that match a reference view. A depth value for a depth position of pixel p in a reference view may be considered valid if a certain number of neighboring views are determined to match the reference view. For example, in some embodiments, a depth value for a depth position of pixel p may be considered valid if at least two neighboring views are determined to match the reference view (e.g., the neighboring views have NCC scores above a certain threshold, as described above). Various embodiments may require a different number of matching neighboring views to consider a depth value valid. In some embodiments, a higher number of matching neighboring views may improve surface coverage for reconstruction of the 3D model from the depth maps. As an example, some embodiments may set the number of neighboring views threshold to four. More than four matching neighboring views may reduce object occlusions, but may not significantly improve results enough to compensate for the additional computation expense that may be required by a larger number of neighboring views.

Depth map module 120 may determine, for each pixel of an object, depth positions which have valid depth values. As described above, a depth value may be valid for a depth position if a minimum number of neighboring views located via the depth position match a reference view corresponding to the pixel. Using the valid depth values corresponding to a pixel, depth map module 120 may determine an overall depth value for the pixel. Various embodiments may use different methods to calculate the overall depth value for the pixel. For example, depth map module 120 may choose, as the overall depth value for the pixel, the depth value corresponding to the depth position with the highest mean NCC score calculated from all neighboring views located via a projection of the depth position.

For each valid depth value, depth map module 120 may calculate a confidence level. The confidence level of a depth map value may indicate the likelihood that the depth map value is an accurate representation of the 3D shape of an object at a particular pixel position. The confidence value may be dependent on the number of valid views for the pixel represented by the depth map value. For example, the confidence value may be equivalent to the number of neighboring windows (of the pixel) which have an NCC score above the required threshold.

The depth values calculated, as described above, for each pixel of an object in a digital image may represent the depth map for that image. In some embodiments, depth map module 120 may use all valid depth values calculated for an image to generate a depth map for the image. In other embodiments, depth map module 120 may use, from the set of depth values calculated for an image, only depth values which are above a certain confidence level to generate a depth map for the image.

The method illustrated in FIG. 6 may include, as indicated at 602, merging the depth maps of the digital images into a tessellated mesh representation of the 3D surface of the imaged object. As described above, a depth map corresponding to a single image may contain one or more incomplete surfaces for an imaged object. For example, in image regions which contain occlusions, low-textured surface areas, and/or oblique surfaces, the depth map for the image may include incomplete surface information. However, such image regions may typically occur at different locations on an imaged object in different images. Accordingly, depth map module 120 may minimize incomplete surface information for an object by merging multiple depth maps.

The tessellated mesh representation creating by merging the multiple depth maps may represent an approximation of the 3D surface of the imaged object. In some embodiments, depth map module 120 may use a volumetric method to merge the multiple depth maps. For example, depth map module 120 may covert each depth map into a weighted distance volume. Depth map module 120 may first create a triangular mesh for each depth map by connecting nearest neighbor depth positions to form triangular surfaces. Depth map module 120 may assign low weighting values to depth positions near depth discontinuities (e.g. at the edge of an object). Each vertex of the triangular mesh may be assigned a weighting based on the confidence level of the depth position corresponding to the vertex. Depth map module 120 may scan convert the weighted vertices into a weighted distance volume. Depth map module 120 may then sum the distance volumes of the multiple triangular meshes (e.g. generated from each of the depth maps) to create a single triangular mesh. The resulting triangular mesh may be an approximation of the 3D surface of the imaged object. Note that the description of a triangular mesh is provided for example only, and is not meant to be limiting. Other embodiments may use other forms of a tessellated, polygonal mesh.

### User-Specified Constraints

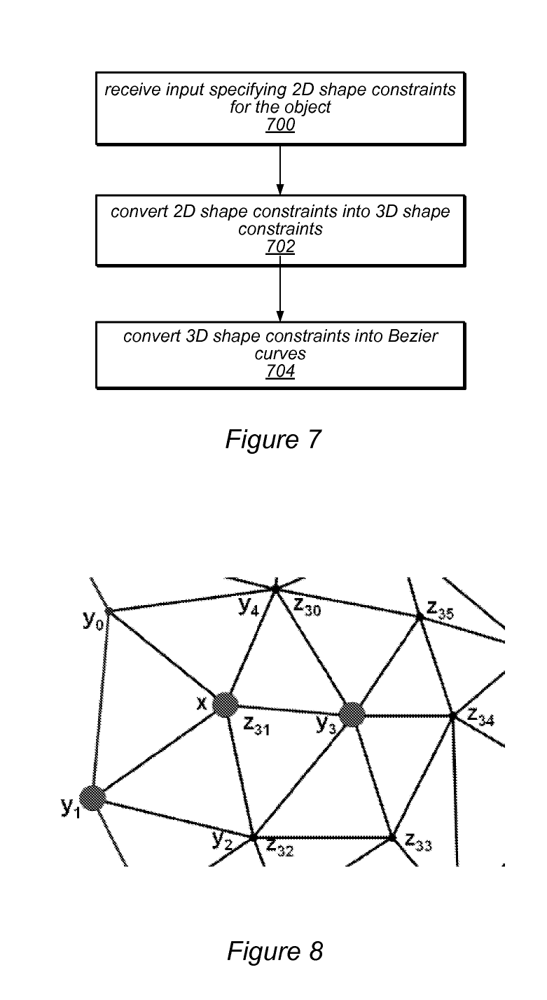

As described above, the constraints which represent a 3D model may be determined from information provided by a user. FIG. 7 illustrates a method that may be used by constraint converter 130 of constraint generation module 100 to receive user-specified shape constraints and convert the user-specified shape constraints into editable, 3D constraints. As indicated at 700, the method may include receiving input which specifies 2D shape constraints for an imaged object. Constraint converter 130 may receive, via user interface 102, user input which may specify shape constraints for the object.

As described above, constraint converter 130 may be configured to present images of an object to a user, either sequentially or in combinations. The user may interact with the images to identify 2D constraints representing curves and/or features that define the surface, or shape, of the imaged object. For example, as illustrated in FIG. 3, the user may identify shape features of the object, such as edges and/or curved surfaces, by drawing or tracing the features on one or more images of the object. In some embodiments, the user may identify other types of 2D constraints which represent shape features of an object such as planar regions bounded by curves and/or line segments, line segments (closed or open), and/or points. Constraint converter 130 may interpret the user-specified 2D constraints as constraints which the user desires to edit in the 3D model of the object.

The method illustrated in FIG. 7, as indicated at 702, may include converting the user-specified 2D shape constraints into 3D shape constraints. To convert the 2D shape constraints into 3D shape constraints, constraint converter 130 may match the specified 2D shape constraints across multiple images. More specifically, for each specified 2D shape constraint, constraint converter 130 may determine which images in the plurality of images of an object contain the specified 2D constraint. Constraint converter 130 may automatically, via an analysis of image data, determine images that contain a particular specified 2D shape constraint. In other embodiments, constraint converter 130 may request that the user specify each 2D shape constraint on all images in which the 2D shape constraint appears. In yet other embodiments, constraint g converter 130 may automatically determine matching 2D constraints across the multiple images for some of the specified 2D constraints and may request that a user specify the remaining specified 2D constraints on all images in which the remaining specified 2D constraints appear.

Constraint converter 130 may use image data and camera parameters for a set of images which have been determined to contain a specified 2D shape constraint to convert the specified 2D shape constraint into a 3D shape constraint. For example, constraint converter 130 may use a method similar to that described above, in reference to 504 of FIG. 5, for generating the 3D shape constraints from the user-specified 2D shape constraints. Constraint converter 130 may use the camera parameters of the images which contain a user-specified 2D shape constraint to 3D surface information for user-specified 2D shape constraint. As described above, the set of digital images 104 may be calibrated, such that intrinsic and extrinsic image and camera parameters for the images are known. For example, digital images 104 may be encoded with information explicitly identifying the camera position (e.g., in terms of geospatial coordinates), focal length, and/or other extrinsic (e.g., positional) and intrinsic parameters relevant to the image capture, such that the relative camera motion around the object that is indicated by different images of the object may be determined from this identifying information.

Constraint converter 130 may determine 3D surface information of a 2D shape constraint identified in multiple images using the camera motion data and other image parameters. For example, using the orientation and lens properties of one or more cameras used to capture multiple images of a region of interest, constraint generation module 100 may perform a triangulation procedure to determine a 3D position of the 2D shape constraint, relative to the camera(s) position. For example, the 3D position and orientation (e.g., unit normal vector) of a patch on the surface of a 3D object may be obtained using relative positional information from image data of multiple images which contain the same patch. Similarly, the 3D positions and orientations of points, edges (e.g., lines or curves) and/or other identified object features may be determined using relative positional information from image data of multiple images which contain the same object feature. The relative 3D positions and/or orientations of a user-specified 2D shape constraint may be converted into a 3D version of the user-specified 2D shape constraint. Examples of 3D constraints that may be created by constraint generation module 100 may include, but are not limited to, 3D planar curves, 3D planar regions, 3D line segments, 3D points and 3D lines.

As indicated at 704, the method illustrated in FIG. 7 may include converting the 3D constraints into Bezier curves. Each of the 3D shape constraints created at 702 may be represented as a set of line segments. A set of line segments may not be a representation of a 3D constraint that is easy, or intuitive, for a user to manipulate in order to change the shape of a 3D model. For example, moving the position of a 3D constraint represented by multiple line segments may require a user to select and move several of the line segments, which may be tedious and/or confusing for a user.

Accordingly, constraint converter 130 may convert the 3D shape constraints into Bezier curves. 3D shape constraints represented by Bezier curves may be intuitively editable by a user.

Constraint converter 130 may convert each 3D shape constraint into a 2D ezier curve via which a user may manipulate to change the shape of a 3D model. To convert a 3D shape constraint into a 2D Bezier curve, constraint converter 130 may identify the 3D plane in which the 3D shape constraint resides. The 3D shape constraint may then be re-parameterized into a 2D curve and the identified 3D plane. The 2D curve may then be converted directly into a Bezier curve. A user may, via user interface 102, edit the 2D Bezier curve by adding and/or removing the control points for the 2D Bezier curve.

### 3D Model Reconstruction

Various techniques may be employed by 3D model generator 140 to reconstruct a 3D surface that satisfies the determined 3D constraints and 3D surface approximation. One such technique, as presented in further detail below, is described in U.S. application Ser. No. 12/276,106 entitled “Method and Apparatus for Surface Inflation Using Surface Normal Constraints,” filed Nov. 21, 2008, the content of which is incorporated by reference herein in its entirety.

Constraint generation module 100 may use the determined 3D constraints to reconstruct a visual 3D model of the imaged object, such as 3D model 150 illustrated in FIG. 1. The visual 3D model may provide a visual representation of the model for a user and may be displayed, as described in further detail below, with a set of editable constraints which a user may manipulate to change the shape of the 3D model. 3D model generator 140 of module 100 may reconstruct the 3D model from the image-based constraints, the user-specified constraints and the 3D surface approximation of the imaged object, obtained as described above. 3D model generator 140 may convert the constraints and surface approximation into a polygonal mesh representation of the 3D model. The polygonal mesh representation of the 3D model may represent a 3D surface that satisfies the determined 3D constraints and 3D surface approximation. 3D model generator 140 may use the polygonal mesh representation of the 3D model to present a visual display of the 3D surface, as 3D model 150, to a user.

The 3D constraints and 3D surface approximation determined as described above may contain parameters which define the shape and/or characteristics of the 3D surface. Each point on a 3D constraint and each vertex of the mesh that represents the 3D surface approximation may contain parameters which specify characteristics of the 3D surface at that particular point. For example, the parameters which represent a point on a 3D constraint or a vertex position may specify the angle of the 3D surface at that particular point and/or the weight of the angle at the particular point. Accordingly, 3D model generator 140 may use the 3D constraints and surface approximation to create a 3D surface that interpolates the 3D shape (e.g. curves and boundaries) represented by the 3D constraints and surface approximation.

3D model generator 140 may determine a specific type for each of the constraints (e.g., image-based constraints, user-specified constraints, and surface approximation vertices) in order to accurately generate the 3D surface of the model. For example, 3D model generator 140 may determine whether each constraint represents an internal or an external boundary. Internal boundaries may indicate that the location at which the 3D surface passes the constraint is continuous. External boundaries may indicate that the location at which the 3D surface passes the constraint is on the boundary of the 3D surface (e.g. the edge of the object).

As another example, 3D model generator 140 may determine whether each constraint is a smooth or sharp constraint. A smooth constraint may indicate that the 3D surface location represented by the constraint is a smooth (e.g., first-order differentiable) surface. A sharp constraint may indicate that the 3D surface location represented by the constraint is a sharp surface. 3D model generator may determine a constraint type by analyzing the characteristics of a constraint, or may request that a user identify the constraint type. Both external and internal boundaries may be constraints on the 3D surface of the model, as the boundaries are fixed in position during generation of the 3D surface. Thus, internal boundaries and external boundaries may be referred to collectively herein as position constraints.

Various embodiments may use mean curvature constraints, surface normal constraints, or a combination of mean curvature constraints and surface normal constraints, as boundary conditions to control the 3D surface generation for the 3D model. Using such constraints, the generation of the 3D surface may be calculated efficiently, using a single linear system, unlike conventional methods. The mean curvature of a surface is an extrinsic measure of curvature that locally describes the curvature of the surface. Thus, a mean curvature constraint is a specified value for the mean curvature at a particular boundary location, e.g. at a particular point or vertex on an external or external boundary, or for a particular segment of an external or internal boundary. A surface normal, or simply normal, to a flat surface is a vector perpendicular to that surface. Similarly, a surface normal to a non-flat surface is a vector perpendicular to the tangent plane at a point on the surface. Thus, a surface normal constraint specifies that, at the particular point on the surface (e.g., at a point on an external or internal boundary of the surface), the surface normal is to point in the specified direction. As an example, a user may want the surface normal at a point on a boundary to be facing 45 degrees out of plane to generate a 45 degree bevel, and thus may set the surface normal constraint to 45 degrees at the point. Surface normal constraint values may be specified at a particular boundary location, e.g. at a particular point or vertex on an external or internal boundary, or for a particular segment of an external or internal boundary.

Various embodiments may use either mean curvature constraints or surface normal constraints as boundary conditions. In some embodiments, both mean curvature constraints and surface normal constraints may be used as boundary conditions; for example, mean curvature constraints may be used on one portion of a boundary, and surface normal constraints may be used on another portion of the same boundary, or on another boundary. The mean curvature constraints and/or surface normal constraints may be applied to internal or external boundaries for the 3D surface generation. In embodiments, different values may be specified for the curvature constraints at different locations on a boundary.

In addition to position constraints (external and internal boundaries), mean curvature constraints and surface normal constraints, some embodiments may allow other types of constraints to be specified. For example, one embodiment may allow pixel-position constraints to be specified at points or regions on a surface; the pixel-position constraints may be used to limit manipulation of the 3D surface along a vector. For example, a pixel-position constraint may be used to limit manipulation to the z axis, and thus prevent undesirable shifting of the surface along the x and y axes. As another example, one embodiment may allow oriented position constraints to be added for surface normal constraints. Some embodiments may also allow arbitrary flow directions to be specified for regions or portions of the surface, or for the entire surface, to be specified. An example is a gravity option that causes the surface to flow “down”.

Embodiments may leverage characteristics of linear variational surface editing techniques to perform the actual 3D surface generation, whether mean curvature constraints, surface normal constraints, or both are used. Linear variational surface editing techniques, using some order of the Laplacian operator to solve for smooth surfaces, may provide simplicity, efficiency and intuitive editing mechanisms for users who desire to edit a 3D model. In contrast to conventional methods that use an implicit surface representation to model surfaces, embodiments may use a polygon (e.g., triangle) mesh to construct a 3D surface that satisfies the determined constraints. In contrast to conventional methods, some embodiments may implement a linear system, working around the deficiencies of the linear system, instead of using a slower, iterative non-linear solver that is not guaranteed to converge. While a linear system approach may not allow the solution of the whole mesh as a unified system, embodiments may provide an alternative patch-based approach which may be more intuitive to users, as the global solve in conventional methods may result in surface edits tending to have frustrating global effects. While embodiments are generally described as using a triangle mesh, other polygon meshes may be used.

By using the mean curvature value or surface normal value stored at or specified for boundary vertices as a degree of freedom, embodiments are able to control the generation of the 3D surface efficiently using a single linear system. Embodiments may handle both smooth and sharp position constraints. Position constraint vertices may also have curvature constraints for controlling the generation of the local surface. Embodiments of the 3D model generator construct a 2-manifold surface that interpolates the input boundary or boundaries. The surface may be computed as a solution to a variational problem. The surface generation method implemented by 3D model generator 140 may be formulated to solve for the final surface in a single, sparse linear equation, without requiring an additional strip of triangles at the boundary. In embodiments that employ mean curvature constraints, the mean curvature of the vertices on the boundary is a degree of freedom; the surface may be generated by increasing these mean curvature values. In embodiments that employ surface normal constraints, additional ghost vertices may be used to control the surface normal internally and at surface boundaries; in this embodiment, the surface may be generated by adjusting the surface normal constraints and thus rotating the boundary's ghost vertices around the boundary. Due to the variational setup, the generated surface is smooth except near position constraints.

### 3D Surface Generation

3D model generator 140 may generate the 3D surface according to the specified constraints while maintaining a fixed boundary. The unconstrained parts of the surface may be obtained by solving a variational system that maintains surface smoothness. Smoothness may be maintained because it gives an organic look to the generated 3D surface and removes any unnatural and unnecessary bumps and creases from the surface.

The variational formulation may be based on the principles of partial differential equation (PDE) based boundary constraint modeling, where the Euler-Lagrange equation of some aesthetic energy functional is solved to yield a smooth surface. One embodiment may use a ‘thin-plate spline’ as the desired surface; the corresponding Euler-Lagrange equation is the biharmonic equation. In this embodiment, for all free vertices at position x, the PDE Δ²(x)=0 is solved. The solution of this PDE yields a C² continuous surface everywhere except at the position constraints (where the surface can be either C¹ or C¹ continuous). One embodiment may use cotangent-weight based discretization of the Laplacian operator Δ(x).

The fourth-order PDE (Δ²(x)=0) may be too slow to solve interactively. Therefore, one embodiment converts the non-linear problem into a linear problem by assuming that the parameterization of the surface is unchanged throughout the solution. In practice, this means that the cotangent weights used for the Laplacian formulation are computed only once and are subsequently unchanged as the 3D surface is generated. This approximation has been used extensively for constructing smooth shape deformations, but it may significantly differ from the correct solution in certain cases. Instead of correcting this with a slower, sometimes-divergent, iterative non-linear solver, embodiments may characterize the linear solution and use its quirks to provide extra dimensions of artist control.

An advantage to using a linear system in the solver is that the linear system has a unique solution. In contrast, non-linear systems may generate multiple solutions (for example, a global and local minimum). Thus, using a non-linear system, the solver may get trapped in a local minimum, possibly yielding an undesired solution (e.g., the global optimum may not be found). Different non-linear solvers may arrive at different local minima. Thus, using a linear system may provide consistency and efficiency. A trade-off to using a linear system is that the resulting surface may not be quite as smooth as a globally optimal solution to a non-linear system. For artistic purposes, however, a solution produced by a linear system is sufficient.

### Linear Systems

### Mean Curvature Constraint Embodiments

The following describes the formulation of a variational linear system according to embodiments that use mean curvature constraints. In these embodiments, a linear system A x̅= b̅ may be implemented, where the matrix A is a sparse n×n matrix (where n is 3× the number of free vertices) that represents the local geometric relationships between the vertices and their neighbors. The vector x̅ of length n represents the positions of free vertices and the vector b̅ of length n represents the known quantities. For all three coordinates of every free vertex, an equation is formulated that is linear in terms of the vertex's neighbors. In one embodiment, the formulation may be based primarily on methods of discrete geometric modeling. A method has been described in the art to formulate a linear system that can handle smooth or sharp internal constraints; unfortunately the formulation requires a strip of triangles to complete the one-ring neighborhood of the boundary vertices. Generating this strip of triangles, especially when the boundary curve has large concavities, is not trivial. In addition, a surface modeling system has been described in the art that takes G¹ boundary constraints and does not need the special triangle strip on the boundary. However, this surface modeling system requires two linear solutions: one for the mean curvature scalar field and another for the positions that satisfy the computed mean curvature field. 3D model generator 140 may combine the benefits of these two approaches. In so combining, embodiments of 3D model generator 140 that use mean curvature constraints do not need a strip of triangles on the boundary to generate the 3D surface, and may solve only one linear system. This is possible because 3D model generator 140 considers the mean curvature at the boundary vertices as a degree of freedom, one that can be used to generate the surface.

One embodiment may use a conjugate-gradient implementation to solve the linear system A x̅= b̅. Since the matrix A is sparse, symmetric and positive-definite, other embodiments may factorize the matrix, which may decrease iterative update times. For example, in one embodiment, a Cholesky decomposition of the matrix A may be performed, and in one embodiment, a direct solver may be used to solve the linear system. Other solvers may be used to solve the linear system in other embodiments. For example, a sparse Cholesky solver or a conjugate-gradient solver may be used. Other techniques such as multi-grid solvers may also be used.

FIG. 8 illustrates a mesh vertex of position x and one-ring neighbors yᵢ according to some embodiments. FIG. 8 illustrates various variables used in the equations below. Vertex x has neighbors y₀, y₁ on the boundary (constrained mean curvature) and neighbors y₂, y₃, y₄ in the interior with a full one-ring neighborhood (unconstrained mean curvature). The required C² smooth surface can be obtained by solving for a surface with a vanishing bi-Laplacian at all vertices:

Δ²(x)=Δ(Δx)=0 (1)

The Laplacian at a mesh vertex is given by its one-ring neighborhood. A discrete Laplace operator may be used, for example the Laplace-Beltrami operator defined for meshes may be used:

$$Δ x = \frac{1}{( 2 {A}_{x} )} ( x - {\sum }_{i} {w}_{i} {y}_{i} )$$

where wᵢ are the normalized cotangent weights and

$$\frac{1}{( 2 {A}_{x} )}$$

is a scaling term that includes the weighted area Aₓ around the vertex x that improves the approximation of the Laplacian. Note that other Laplace operators for meshes may be used in various embodiments. Substituting in equation (1):

$${Δ}^{2} x = \frac{1}{( 2 {A}_{x} )} Δ ( x - {\sum }_{i} {w}_{i} {y}_{i} ) = 0 \qquad ( 2 )$$

Since A is a linear operator:

$${Δ}^{2} x = Δ x - {\sum }_{i}^{ } {w}_{i} Δ {y}_{i} = 0 \qquad ( 3 )$$

Consider the situation in FIG. 8, where some one-ring neighbors are in the mesh interior, and some are on the boundary. It is assumed that the mean curvature of the boundary vertices is given as a constraint. Assume yᵢ represents the one-ring vertices whose mean curvatures hyⱼ are known. For those vertices, the Laplacians may be computed simply by using the expression Δyⱼ=(h_{y}n_{y})/2. Moving such known Laplacians to the right hand side of equation (3), the following is obtained:

$${Δ}^{2} x = 0 ⇒ Δ x - {\sum }_{i}^{ } {w}_{i} Δ {y}_{i} = {\sum }_{j} \frac{{w}_{j} {h}_{{y}_{j}} {n}_{{y}_{j}}}{2} \qquad ( 4 )$$

Note that the term (h_{y}_{ⱼ}n_{y}_{ⱼ})/2 essentially represents a force of magnitude 0.5hyⱼ in the direction nyⱼ applied by the neighboring vertex yⱼ on vertex x. In some embodiments, the force is applied in the direction of the initial vertex normal (the normal in the flat configuration—the Z axis). One embodiment does not use the vertex normals from the generated state, as that may produce non-linear vertex motion that is path-dependent and unintuitive.

Therefore, by increasing the value of hyⱼ, the magnitude of the force on the vertex x is increased, effectively pushing it up.

Finally, the Laplacians of vertices with unknown mean curvatures is expanded in equation (3) to get the linear equation for the free vertex x:

$$x - {\sum }_{i}^{ } {w}_{i} {y}_{i} - {\sum }_{i}^{ } {w}_{i} [ {y}_{i} - {\sum }_{k}^{ } {w}_{ik} {z}_{ik} ] = {\sum }_{i}^{ } \frac{{w}_{j} {h}_{{y}_{j}} {n}_{{y}_{j}}}{2} \qquad ( 5 )$$

Constructing such equations for every free vertex yields the linear system A x̅= b̅, the solution of which provides the generated 3D surface.

### Surface Normal Constraint Embodiments

The following describes the formulation of a variational linear system according to embodiments that use surface normal constraints. In embodiments, a linear system A x̅= b̅ may be implemented, where the matrix A is a sparse n×n matrix (where n is 3× the number of free vertices) that represents the local geometric relationships between the vertices and their neighbors. The vector x̅ of length n represents the positions of free vertices and the vector b̅ of length n represents the known quantities. For all three coordinates of every free vertex, an equation is formulated that is linear in terms of the vertex's neighbors. In this embodiment, the formulation may be based primarily on a method of discrete geometric modeling, with the addition of constraint types. A method has been described in the art to formulate a linear system that can handle smooth or sharp internal constraints; unfortunately, the formulation requires a strip of triangles to complete the one-ring neighborhood of the boundary vertices. Generating this strip of triangles, especially when the boundary curve has large concavities, is not trivial. Therefore, embodiments of 3D model generator 140 that use a surface normal constraint provide a method to “fake” these triangles with locally-correct “ghost” vertices.

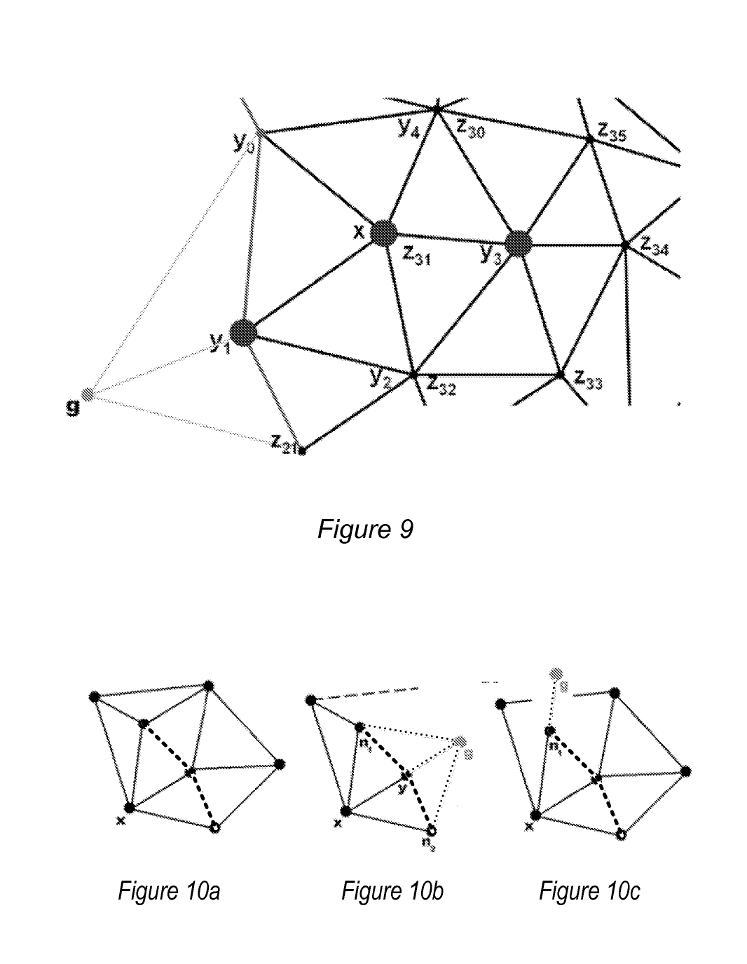

FIG. 9 illustrates a mesh vertex of position x and one-ring neighbors yᵢ according to some embodiments. FIG. 9 shows various variables used in the equations below. Vertex x has neighbors y₀, y₁ on the boundary, and neighbors y₂, y₃, y₄ in the interior with a full one-ring neighborhood. Each boundary vertex has its own ghost vertex and two corresponding ghost triangles—for example, y₁ has ghost vertex g—to artificially provide the required one-ring neighborhood.

Consider a mesh vertex of position x and one-ring neighbors yᵢ as shown in FIG. 9. A C² smooth surface can be obtained by solving for a surface with a vanishing bi-Laplacian at all vertices:

Δ²(x)=Δ(Δx)=0 (6)

The Laplacian at a mesh vertex is given by its one-ring neighborhood:

Δx=Σᵢwᵢ(x−yᵢ)

where wᵢ are the unnormalized cotangent weights scaled by inverse vertex area. Substituting in equation (6):

$${Δ}^{2} x = Δ ( {\sum }_{i} {w}_{i} ( x - {y}_{i} ) ) = 0 \qquad ( 7 )$$

Since Δ is a linear operator:

$${Δ}^{2} x = {\sum }_{i} {w}_{i} Δ x - {\sum }_{i} {w}_{i} Δ {y}_{i} = 0 \qquad ( 8 )$$

This expands finally to:

$${( {\sum }_{i} {w}_{i} )}^{2} x - ( {\sum }_{i} {w}_{i} ) ( {\sum }_{i} {w}_{i} {y}_{i} ) - {\sum }_{i} {w}_{i} [ ( {\sum }_{k} {w}_{ik} ) {y}_{i} - {\sum }_{k} {w}_{ik} {z}_{ik} ] = 0 \qquad ( 9 )$$

where zᵢₖ refers to ghost vertices where necessary to complete a one-ring. Constrained vertices may be treated as absolute constraints, so their positions are moved to the right hand side of the system. Because it may be convenient to over-constrain the system, and satisfy other types of constraints in a least squares sense, in some embodiments the whole equation may be scaled by the inverse of:

$${( {\sum }_{i} {w}_{i} )}^{2}$$

so that the magnitude of errors will be proportional to a difference in positions, and not scaled by any area or mean curvature values. Constructing such equations for every free vertex gives the linear system A x̅= b̅, whose solution provides the generated 3D surface. Since the construction is not symmetric and may be over-constrained, it may be solved using the normal equations.

### Placement of Ghost Vertices

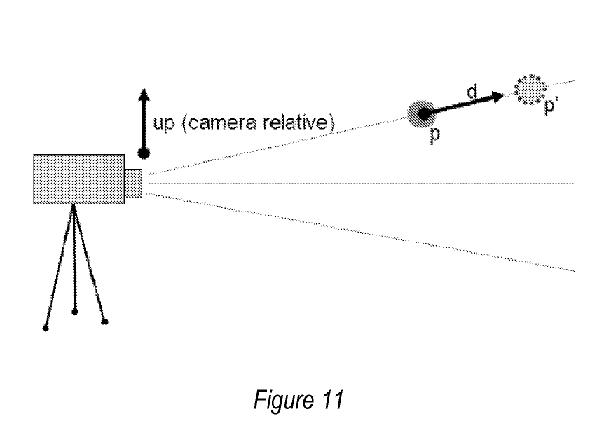

For each patch of a mesh surface, a canonical view direction may be assumed to be known; this may be the direction from which, for example, an original photograph was taken, or from which the original boundary constraints were drawn. An ‘up’ vector which points towards the camera of this canonical view may be derived. Ghost vertices may then be placed in a plane perpendicular to the ‘up’ vector, and normal to the constraint curve of their parent vertex. Each ghost vertex may be placed the same fixed distance d from the curve. For example, in FIG. 11, assuming a vector out of the page u, the ghost vertex g is positioned at:

y₁+d(u×(z₂₁−y₀))/∥u×(z₂₁−y₀)∥

The ghost vertices may then be rotated about the tangent of the constraint curve (the boundary) to change the normal direction. Note that ghost vertices may be added for both external and internal boundaries.

### Smoothness of Position Constraints

Either smooth (C¹) or sharp (C⁰) position constraints may be specified. The smoothness value may be varied by assigning a weight to the constrained vertex in equation (5) or in equation (9). In one embodiment, the weight that controls the smoothness of the position constraints may take any floating point value between 0 (C⁰ continuous) and 1 (C¹ continuous). However, in one embodiment, it may be useful to have only two options (smooth/sharp), and to draw position constraints with a fixed smoothness for all vertices. Other embodiments may allow the use of varying smoothness across individual position constraints.

### Curvature Constraints

Curvature constraints may be specified along with position constraints. When the value of a curvature constraint is modified, the surface is modified so that the approximation of the mean curvature at the constraint point matches the value of the curvature constraint. The curvature constraint may be used to locally inflate or deflate the surface around the position-constrained vertices. As such, embodiments may provide a sketch-based modeling gesture. In some embodiments, the initial value for the curvature constraint is set to zero, but in other embodiments the initial value may be set to any arbitrary value.

### Options for Constraints

Assigning a mean curvature constraint or a surface normal constraint to a vertex is an indirect method of applying a force to the one-ring neighbors of the vertex along the direction perpendicular to the initial, flat surface. However, in some embodiments, the default behavior may be modified, and additional forces may be applied in arbitrary directions. As an example, in some embodiments, a ‘gravity’ option may be added to the curvature constraints where another force is applied in a slightly downward direction (to the right hand side of equation (5)), causing the entire surface to bend downwards. This may be used, for example, to create the illusion of a viscous material on a vertical plane. In some embodiments, other directions than “down” may be specified to cause the surface to flow in a specified direction.

### Oriented Position Constraints

The ghost vertex concept described for surface normal constraints may be extended to internal boundaries that may be used to control the orientation of the surface along the internal boundaries. In some embodiments, to do so, the way the Laplacian at the constrained vertex is calculated may be modified, as shown in FIGS. 10a through 10c. As seen in FIGS. 10a through 10c, the ghost Laplacians extend naturally to internal boundaries except at the endpoints of open internal boundaries; here there are no longer well defined sides of the curve (especially for internal boundaries which are just a single point) and therefore a different method should be used for computing the Laplacian. The Laplacian in this degenerate case may be defined using just the originating vertex x for which the biLaplacian is being computed and the opposing ghost vertex g as the “‘one ring’” of the constrained vertex. Since the measures of vertex area and cotangent weights do not extend to this case, the sum of area-normalized cotangent weights from the originating vertex may be used. The method then lets the two vertices share that weight sum equally. Therefore, the Laplacian may be defined as:

(wᵢ/Σᵢwᵢ)yᵢ−(g+x)wᵢ/(2Σᵢwᵢ)

FIGS. 10a through 10c illustrate oriented position constraints according to some embodiments. An internal oriented position constraint line is shown in FIG. 10a. When calculating the biLaplacian of vertex x, some embodiments may calculate the Laplacian at y by creating ghost g, so the one ring of vertex y is (x, n1, g, n2) as shown in FIG. 10b. Note that n₁ is on the end of the constraint line, so to compute its Laplacian g is instead placed along the vector from x to n₁, and the Laplacian at n₁ is computed using only vertices x, n₁, and g.

### Pixel-position Constraints

FIG. 11 illustrates pixel-position constraints according to some embodiments. Referring to FIG. 11, a pixel-position constraint allows a vertex p to move freely along vector d. A user may wish to constrain a vertex (or a region) on the surface to always project to the same position in screen space from a given view, without fully constraining the position of that vertex or region. In some embodiments, this may be allowed by over-constraining the linear system with additional constraints referred to as pixel-position constraints. These constraints may be written into the matrix as two linear constraints for two arbitrary unit vectors orthogonal to the camera ray d−o₁ and o₂. For a point p with initial position p′, the constraint equations are o₁·(p−p′)=0, and the equivalent for o₂.

Note that without pixel-position constraints, the linear system may be written separately for x, y and z, but for arbitrary pixel position constraints, x, y and z may be arbitrarily coupled. This may have a performance cost, as the matrix would be nine times larger. For less free-form applications, it may therefore be useful to keep the system decoupled by implementing pixel-position constraints only for axis-aligned orthogonal views. In these cases the constraint is simply implemented by fixing the vertex coordinates in two dimensions and leaving it free in the third.

Pixel position constraints may be used with mean curvature constraints, with surface normal constraints, or with a combination of mean curvature constraints and surface normal constraints.

### Mixing Pixel-position and Orientation Constraints

In many cases, orientation and pixel-position are known, but it may not be desired by the artist to fix the position fully—for example, when modeling a face, there may be a certain angle at the nose, but the artist may still want to allow the nose to move smoothly out when puffing out the cheeks of the character. To allow this, some embodiments may mix pixel-position and orientation constraints. The vertex loses its biLaplacian smoothness constraints, and gains ghost vertices and pixel-position constraints. Ghost vertices are specified relative to the free vertices of the pixel-position constraint, instead of absolutely. However, this removes three biLaplacian constraint rows in the matrix for every two pixel-position rows it adds (assuming a coupled system) making the system under-constrained. Therefore, additional constraints may be needed. For a first additional constraint, it may be observed that when a user draws a line of pixel-position constraints, they likely want the line to retain some smoothness or original shape. For adjacent vertices p₁, p₂ on the constraint line, which are permitted to move along vectors d₁ and d₂ respectively, some embodiments may therefore constrain the vertices to satisfy:

(p₁−p₂)·(d₁+d₂)/2=0

Since the system is still one constraint short, some embodiments may add an additional constraint specifying that the Laplacian at the endpoints of the constraint line (computed without any ghost vertices) should match the expected value (which is known by the location of the ghost vertices relative to the constraint curve). Scaling these Laplacian constraints adjusts the extent to which the constrained vertices move to satisfy the normal constraints.

### Exploiting the Linearization

The system described herein is a linear system because the non-linear area and cotangent terms have been made constant, as calculated in some original configuration. The linearization may be thought of as allowing the ‘stretch’ of triangles to be considered as curvature, in addition to actual curvature; therefore variation is minimized in triangle stretch+curvature, instead of just curvature. In some embodiments, this can be exploited by intentionally stretching triangles: for example, by intentionally moving ghost vertices, area of effect of the ghost vertices may be increased. This is similar to moving a Bezier control point along the tangent of a curve.

The linearization may also cause the solution to collapse to a plane if all of the control vertices are coplanar. This may be visible in the system as the ghost vertices at the boundaries are rotated to be coplanar and inside the shape, resulting in a flat, folded shape. However, in some embodiments, the need for modeling this shape with a single linear system may be avoided by allowing the system to be used as a patch-based modeling system, with ghost vertices enforcing C¹ continuity across patch boundaries.

In other embodiments, 3D model generator 140 may employ other techniques to reconstruct a 3D surface that satisfies the determined 3D constraints (e.g., image-based constraints and user-specified constraints) and 3D surface approximation. As an example, the 3D constraints described above may include confidence values, such as the confidence values described above which may indicate the likelihood that a depth map value accurately represents the 3D shape of an object at a particular pixel position on the object in an image. 3D model generator 140 may reconstruct the 3D surface of the object using a minimal energy surface reconstruction technique (similar to that described above) which may consider the various confidence values of the 3D constraints when reconstructing the 3D surface.

### 3D Model Display and Manipulation

The set of 3D constraints may provide a complete representation of the 3D model. For example, the 3D model may be stored in a computer-accessible medium by writing or storing the set of 3D constraints on any of various types of memory media, such as storage media or storage devices. The 3D model may be fully reconstructed, for example, for visual display and modification, from the set of 3D constraints. More specifically, the set of 3D constraints which represent the 3D model may be stored and subsequently retrieved from system memory as a persistent shape representation. The set of 3D constraints which represent the 3D model may include the editable constraints defined by a user and transformed into editable 3D constraints by constraint converter 130. Accordingly, the editable constraints may be stored, with the other determined constraints, as a representation of the 3D model.

Conventional methods store complex representations of 3D surfaces (for example, a connected mesh representation) of a 3D model, rather than 3D constraints which define the shape of the 3D model. Storing a set of 3D constraints, including editable 3D constraints, may provide an advantage to a user. A 3D model reconstructed from a stored set of 3D constraints which includes editable 3D constraints may present the set of editable 3D constraints to the user for editing and manipulation of the 3D model. Accordingly, the stored set of 3D constraints may enable the user to conveniently create multiple versions of the 3D model via multiple iterations of edits executed over a period of time. To support each iteration of edits, the system may reconstruct the 3D model from the set of constraints and display, to the user, the 3D model, including the set of editable constraints. The set of editable constraints displayed on the 3D model may represent the most recent edits to the 3D model completed by the user. Accordingly, it may be convenient for the user to continue editing the shape of the 3D model through further manipulation of the 3D constraints.

In some instances, a user may wish to save a surface region of a 3D model in addition to the set of constraints that represent the 3D model. In such instances, the user may specify the surface region on the visual display of the 3D model and the system may use a multi-view stereo reconstruction algorithm, as described above, to compute the detail surface structure of the specified region. The surface region may not be editable by the user, but may be stored as part of the representation of the 3D model. For example, the system may store the detailed surface structure and corresponding boundary information, along with the set of 3D constraints, as a representation of the 3D model.

The set of editable 3D constraints may be displayed to a user by superimposing the editable 3D constraints on a visual display of the 3D model. For example, as illustrated in FIG. 4, the editable 3D constraints may visually outline the one or more shape features of the 3D model. The displayed editable 3D constraints may be editable versions of the constraints previously specified by the user on multiple images of the object, as described above. The editable 3D constraints displayed on the 3D model may be a set of “live” constraints which may be manipulated, by the user, directly on the 3D model to modify the shape of the 3D model. For example, a user may select an editable constraint and modify the shape of the 3D model associated with the selected constraint by dragging, pulling, pushing or otherwise manipulating the constraint. In some embodiments, a user may add new editable constraints to the visual display of the 3D model. A user may draw or trace the constraints on the visual display of the 3D model, in a manner similar to that described above for specifying constraints on one or more images of the model. As an example, a user may add a sharp line constraint to a smooth region of the 3D model and subsequently modify the line to change the 3D shape of the smooth region. A user may also delete editable constraints from the visual display of the 3D model.

The visual display of the 3D model may be updated, using the linear system (or similar process) described above, to reflect the changes made to the constraint by the user. In some embodiments, the visual display of the 3D model may be updated in real-time, as the user manipulates the model via the editable constraints. In other embodiments, visual display of the 3D model may be updated after the manipulation is completed. For example, the system may wait a pre-determined amount of time after user manipulation of the model has ceased to update the visual display of the 3D model. In yet other embodiments, the movement of the editable constraint may be displayed and the visual display of the 3D model may be updated according to the new constraint after the user manipulation of the constraint is complete.

### Example System

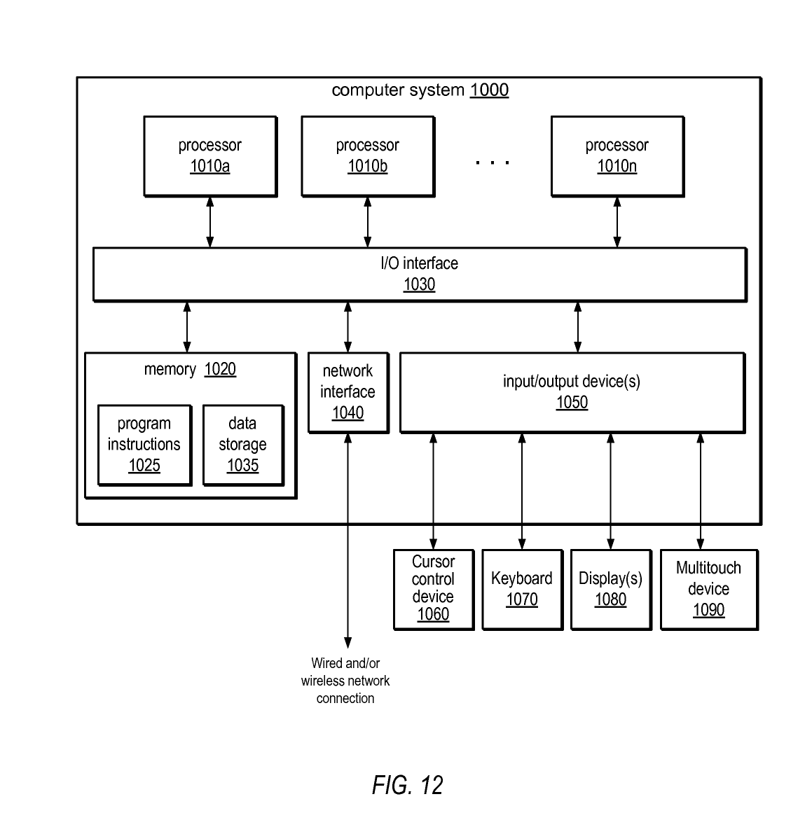

Various components of embodiments of methods as illustrated and described in the accompanying description may be executed on one or more computer systems, which may interact with various other devices. One such computer system is illustrated by FIG. 12. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 12, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A method, comprising:
receiving a plurality of two-dimensional (2D) images of an object from different viewpoints of the object;
receiving input on a display in a user of one or more of the 2D images specifying one or more shape constraints for the object before generating a three dimensional (3D) model of the object, one or more shape constraints specifying a shape of the object;
generating the 3D model of the object dependent on the plurality of images and the one or more specified shape constraints; and
generating a plurality of editable constraints for the 3D model in which at least one of the plurality of editable constraints is dependent on the one or more specified shape constraints and one or more of the plurality of editable constraints are generated that are not dependent on the one or more specified shape constraints, each of the plurality of editable constraints is manipulable by a user via the use interface to change the shape of the object.

2. The method of claim 1, wherein said receiving input comprises receiving user input via a user interface, wherein the user input outlines shape features of the object on a display of one or more of the plurality of images of the object to indicate the one or more specified shape constraints.

3. The method of claim 1, further comprising:
extracting a plurality of image-based constraints from image data and camera parameters for the plurality of images, wherein said generating the 3D model of the object is dependent on the plurality of image-based constraints; and
wherein said extracting comprises:
analyzing image data for each one of the plurality of images to identify regions of interest within each image;
locating digital images which include similar regions of interest;
determining, from the camera parameters of the located digital images, 3D surface information for each identified region of interest; and
generating the image-based constraints from the 3D surface information.

4. The method of claim 1, further comprising:
creating an approximation of a 3D surface of the object from image data and camera parameters for the plurality of images, wherein said generating the 3D model of the object is dependent on the approximation of the 3D surface; and
wherein said creating comprises:
generating a plurality of depth maps, wherein for each respective one of the plurality of images, a depth map is generated dependent on image data and camera parameters for the respective one of the plurality of images; and
merging the plurality of depth maps to generate the approximation of the 3D surface of the object, wherein the plurality of depth maps are merged to create a first tessellated mesh, and wherein the first tessellated mesh represents the approximation of the 3D surface of the object.

5. The method of claim 3, wherein
said generating the 3D model of the object comprises generating a second tessellated mesh which represents the surface of the 3D model, wherein the second tessellated mesh is generated according to constraint values indicated for a plurality of positions for the image-based constraints and for the specified shape constraints and vertex constraint values indicated for a plurality of vertices of the first tessellated mesh.

6. The method of claim 1, wherein the specified shape constraints for the object are 2D shape constraints and wherein said generating a plurality of editable constraints for the 3D model comprises:
converting the 2D shape constraints into 3D shape constraints; and
converting the 3D shape constraints into Bezier curves.

7. The method of claim 1, further comprising:
presenting a visual display of the 3D model of the object;
presenting, as part of the visual display of the 3D model of the object, the plurality of editable constraints as a plurality of handles for modifying the shape of the 3D model;
receiving user input which manipulates one or more of the plurality of editable constraints, wherein the manipulation of the one or more of the plurality of editable constraints indicates one or more modifications to the shape of the 3D model; and
storing a description of the editable constraints as a representation of the 3D model, without saving a connected mesh representation of the 3D model.

8. A system, comprising:
a memory; and
one or more processors coupled to the memory, wherein the memory comprises program instructions executable by the one or more processors to implement a constraint generation module configured to:
receive a plurality of two-dimensional (2D) images of an object from different viewpoints of the object;
receive input on a display in a user interface of one or more of the 2D images specifying one or more shape constraints for the object before generating a three dimensional (3D) model of the object, the one or more shape constraints specifying a shape of the object;
generate the 3D model of the object dependent on the plurality of images and the one or more specified shape constraints; and
generate one or more editable constraints for the 3D model that are not dependent on the one or more specified shape constraints; and
generate at least one editable constraint for the 3D model that is dependent on the one or more specified shape constraints.

9. The system of claim 8, wherein said receiving input comprises receiving user input via a user interface, wherein the user input outlines shape features of the object on a display of one or more of the plurality of images of the object to indicate the one or more specified shape constraints.

10. The system of claim 8, wherein the constraint generation module is further configured to generate the one or more editable constraints that are not dependent on the one or more specified shape constraints by:
extracting a plurality of image-based constraints from image data and camera parameters for the plurality of images, wherein said generating the 3D model of the object is dependent on the plurality of image-based constraints; and
wherein said extracting comprises:
analyzing image data for each one of the plurality of images to identify regions of interest within each image;
locating digital images which include similar regions of interest;
determining, from the camera parameters of the located digital images, 3D surface information for each identified region of interest; and
generating the image-based constraints from the 3D surface information.

11. The system of claim 8, wherein the constraint generation module is further configured to:
create an approximation of a 3D surface of the object from image data and camera parameters for the plurality of images, wherein said generating the 3D model of the object is dependent on the approximation of the 3D surface;
and
wherein said creating comprises:
generating a plurality of depth maps, wherein for each respective one of the plurality of images, a depth map is generated dependent on image data and camera parameters for the respective one of the plurality of images; and
merging the plurality of depth maps to generate the approximation of the 3D surface of the object, wherein the plurality of depth maps are merged to create a first tessellated mesh, and wherein the first tessellated mesh represents the approximation of the 3D surface of the object.

12. The system of claim 10, wherein
said generating the 3D model of the object comprises generating a second tessellated mesh which represents the surface of the 3D model, wherein the second tessellated mesh is generated according to constraint values indicated for a plurality of positions for the image-based constraints and the specified shape constraints and vertex constraint values indicated for a plurality of vertices of the first tessellated mesh.

13. The system of claim 8, wherein the specified shape constraints for the object are 2D shape constraints and wherein said generating a plurality of editable constraints for the 3D model comprises:
converting the 2D shape constraints to 3D shape constraints; and
converting the 3D shape constraints to Bezier curves.

14. The system of claim 8, wherein the constraint generation module is further configured to:
present a visual display of the 3D model of the object;
present, as part of the visual display of the 3D model of the object, the one or more editable constraints and the at least one editable constraint as a plurality of handles for modifying the shape of the 3D model;
receive user input which manipulates one or more of the plurality of editable constraints, wherein the manipulation of the one or more said editable constraints indicates one or more modifications to the shape of the 3D model; and
store a description of the editable constraints as a representation of the 3D model, without saving a connected mesh representation of the 3D model.

15. A computer-readable storage medium, which is not a propagating transitory signal, storing program instructions executable on a computer to implement a constraint generation module configured to:
receive a plurality of two-dimensional (2D) images of an object from different viewpoints of the object;
receive input on a display of a user interface having one or more of the 2D images specifying one or more shape constraints that specify a shape of a portion of a boundary for the object before generating a three dimensional (3D) model of the object;
generate the 3D model as a mesh of feature points of the object dependent on the plurality of images and the one or more specified shape constraints; and
generate a plurality of editable constraints as corresponding to one or more of the feature points of the 3D model dependent on the one or more specified shape constraints that are manipulable by a user via the user interface to change the shape of the object, in which the feature points that do no correspond to the editable constraints are not manipulable to change the shape of the object.

16. The computer-readable storage medium of claim 15, wherein said receiving input comprises receiving user input via a user interface, wherein the user input outlines shape features of the object on a display of one or more of the plurality of images of the object to indicate the one or more specified shape constraints.

17. The computer-readable storage medium of claim 15, wherein the constraint generation module is further configured to:
extract a plurality of image-based constraints from image data and camera parameters for the plurality of images, wherein said generating the 3D model of the object is dependent on the plurality of image-based constraints; and
wherein said extracting comprises:
analyzing image data for each one of the plurality of images to identify regions of interest within each image;
locating digital images which include similar regions of interest;
determining, from the camera parameters of the located digital images, 3D surface information for each identified region of interest; and
generating the image-based constraints from the 3D surface information.

18. The computer-readable storage medium of claim 17, wherein the constraint generation module is further configured to:
create an approximation of a 3D surface of the object from image data and camera parameters for the plurality of images, wherein said generating the 3D model of the object is dependent on the approximation of the 3D surface; and
wherein said creating comprises:
generate a plurality of depth maps, wherein for each respective one of the plurality of images, a depth map is generated dependent on image data and camera parameters for the respective one of the plurality of images; and
merging the plurality of depth maps to generate the approximation of the 3D surface of the object, wherein the plurality of depth maps are merged to create a first tessellated mesh, and wherein the first tessellated mesh represents the approximation of the 3D surface of the object.

19. The computer-readable storage medium of claim 18, wherein
said generating a 3D model of the object comprises generating a second tessellated mesh which represents the surface of the 3D model, wherein the second tessellated mesh is generated according to constraint values indicated for a plurality of positions for the image-based constraints and for the specified shape constraints and vertex constraint values indicated for a plurality of vertices of the first tessellated mesh.

20. The computer-readable storage medium of claim 15, wherein the constraint generation module is further configured to:
present a visual display of the 3D model of the object;
present, as part of the visual display of the 3D model of the object, the plurality of editable constraints as a plurality of handles for modifying the shape of the 3D model;
receive user input which manipulates one or more of the plurality of editable constraints, wherein the manipulation of the one or more of the plurality of editable constraints indicates modifications to the shape of the 3D model; and
store a description of the editable constraints as a representation of the 3D model, without saving a connected mesh representation of the 3D model.
